(19) United States
(12) Patent Application Publication
(10) Pub. No.: US 2016/0041635 A1
(43) Pub. Date: Feb. 11, 2016

(54) ACTIVE STYLUS PEN, ELECTRONIC DEVICE AND DATA INPUT SYSTEM

(71) Applicant: Kabushiki Kaisha Toshiba, Tokyo (JP)

(72) Inventors: Saori Michihata, Sagamihara Kanagawa (JP); Toshiya Takano, Sagamihara Kanagawa (JP); Isao Ohba, Tokyo (JP)

(21) Appl. No.: 14/585,007

(22) Filed: Dec. 29, 2014

Related U.S. Application Data
(60) Provisional application No. 62/035,206, filed on Aug. 8, 2014.

(51) Int. Cl. G06F 3/0354; G06F 3/0488

(52) U.S. Cl. CPC G06F 3/03545; G06F 3/04883

(57) ABSTRACT

According to one embodiment, an active stylus pen includes a first signal generator, a second signal generator and a transmitter. The first signal generator generates a first signal capable of notifying an electronic device capable of accepting an operation executed by the active stylus pen that the pen tip is in contact with the electronic device when an operation of bringing the pen tip into contact with the electronic device is executed. The second signal generator generates a second signal capable of notifying the electronic device that the eraser is in contact with the electronic device when an operation of bringing the eraser into contact with the electronic device is executed.

### CROSS-REFERENCE TO RELATED APPLICATIONS

This application claims the benefit of U.S. Provisional Application No. 62/035,206, filed Aug. 8, 2014, the entire contents of which are incorporated herein by reference.

### FIELD

Embodiments described herein relate generally to an active stylus pen, an electronic device and a data input system.

### BACKGROUND

Recently, electronic devices called tablets or phablets including, for example, a capacitive touchpanel have become widespread. In the capacitive touchpanel, a weak current produced when a finger touches a screen, i.e., capacitance (electrical quantity) is detected and a position contacted (touched) by the finger can be thereby detected. Therefore, an operation for the electronic device can be executed by the user's finger. In such an electronic device, the operation can be executed not only by the user's finger, but also by a pen (stylus pen) compatible with the capacitive touchpanel.

The electronic device of this type often has a function (handwriting input function) enabling input of characters in handwriting so as to facilitate the input operation executed by the user.

Incidentally, in order to obtain capacitance which can be detected by the capacitive touchpanel, a certain degree of contact area is necessary. Accordingly, the pen tip of the pen compatible with the capacitive touchpanel is thicker than that of a well-known digitizer. Therefore, when the handwriting input function is used, small characters can hardly be written.

To solve the problem, a pen (hereinafter referred to as an active stylus pen) equipped with a built-in battery and including a mechanism which notifies a touchpanel of a contact position with the touchpanel (sensor) by changing capacitance at the contact position has been developed. Since the pen tip of such an active stylus pen can be thinner than the pen tip of the general pen described above, small characters can be easily written.

Therefore, as a new input interface, attention has been focused on character input using the active stylus pen in an electronic device (for example, a tablet, etc.) having a character input function.

Incidentally, there is a demand from users of the above-described active stylus pen that the end opposite to the pen tip be used as an eraser like that on an eraser of a lead pencil with the eraser. More specifically, a mechanism for writing by means of the pen tip, and erasing a drawn line on the touchpanel by inverting the pen and moving the pen over the touchpanel if an writing error occurs (i.e., implementation of an eraser function) is desired.

An eraser function already implemented in the active stylus pen switches between a writing function and the eraser function by pressing a side button provided on the active stylus pen. According to this implementation method, however, the inconvenience of accidentally pressing the side switch while writing and unintentionally erasing a drawn line may occur. Therefore, a mechanism capable of using the eraser function by an intuitive operation such as using the end opposite to the pen tip as an eraser like that on an eraser of a lead pencil with the eraser is required to be implemented.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates an appearance of an electronic device and an active stylus pen constituting a data input system of one of embodiments.

FIG. 2 is a block diagram showing a system configuration of the electronic device of the embodiment.

FIG. 3 illustrates an appearance of the active stylus pen of the embodiment.

FIG. 4 is a block diagram showing a system configuration of the active stylus pen of the embodiment.

FIG. 5A illustrates an example of a waveform of a transmission signal generated when a pen tip of the active stylus pen of the embodiment contacts the electronic device.

FIG. 5B illustrates an example of a waveform of a transmission signal generated when an eraser of the active stylus pen of the embodiment contacts the electronic device.

FIG. 6 is a flowchart showing an example of actions of the active stylus pen of the embodiment.

FIG. 7 is a flowchart showing an example of actions of the electronic device of the embodiment.

FIG. 8A illustrates a ground contact area of the pen tip of the active stylus pen of the embodiment.

FIG. 8B illustrates a ground contact area of the eraser of the active stylus pen of the embodiment.

### DETAILED DESCRIPTION

Various embodiments will be described hereinafter with reference to the accompanying drawings.

In general, according to one embodiment, an active stylus pen is actuated by power supplied from a built-in power storage device. The active stylus pen includes a conductive pen tip and a conductive eraser capable of being arranged at a position facing the pen tip. The active stylus pen includes a first signal generator, a second signal generator and a transmitter. The first signal generator generates a first signal capable of notifying an electronic device capable of accepting an operation executed by the active stylus pen that the pen tip is in contact with the electronic device when an operation of bringing the pen tip into contact with the electronic device is executed. The second signal generator generates a second signal capable of notifying the electronic device that the eraser is in contact with the electronic device when an operation of bringing the eraser into contact with the electronic device is executed. The transmitter outputs any one of the first signal and the second signal to the electronic device in order to enable a predetermined function of the electronic device corresponding to the first signal or the second signal. The first signal and the second signal are AC signals configured to increase a capacitance change in a touchpanel included in the electronic device when the active stylus pen is moved to be close to the touchpanel.

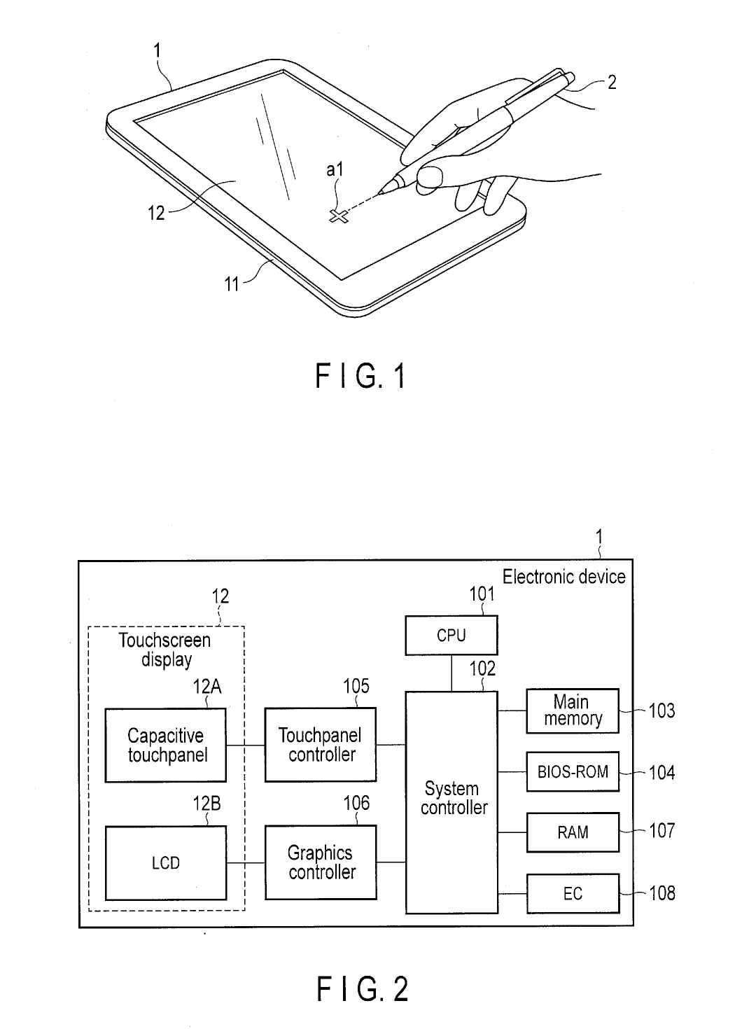

FIG. 1 illustrates an appearance of an electronic device 1 and an active stylus pen 2 constituting a data input system of the embodiment.

In the present embodiment, the electronic device 1 is, for example, a device which can be operated by the active stylus pen 2 or a user's finger. The electronic device 1 can be implemented as, for example, a tablet computer, a smartphone, etc. In FIG. 1, the electronic device 1 is implemented as a tablet computer. The tablet computer is a portable electronic device which is also called a tablet or a slate computer.

As shown in FIG. 1, the electronic device 1 includes a body 11 and a touchscreen display 12. The touchscreen display 12 is attached to the body 11 to overlap a top surface of the body 11.

The body 11 has a thin box-shaped housing. A flatpanel display and a sensor which detects a contact position of the active stylus pen 2 or the user's finger on the flatpanel display are incorporated into the touchscreen display 12. The sensor is a capacitive touchpanel and has a function of supporting the active stylus pen 2. The flatpanel display includes, for example, an LCD. The touchpanel is provided to cover a screen of the flatpanel display.

The electronic device 1 has a function (hereinafter referred to as a hovering function) of displaying a mark (hover) al as a guide at a position on the touchscreen display 12 pointed to by a pen tip of the active stylus pen 2 which is not in contact with the touchscreen display 12 based on a transmission signal output from the active stylus pen 2 as described later.

The electronic device 1 also has a function of inputting characters in handwriting by using the active stylus pen 2.

FIG. 2 shows a system configuration of the electronic device 1. As shown in FIG. 2, the electronic device 1 includes a CPU 101, a system controller 102, a main memory 103, a BIOS-ROM 104, a touchpanel controller 105, a graphics controller 106, a RAM 107 and an EC 108. The touchscreen display 12 of the electronic device 1 shown in FIG. 1 includes the above-described touchpanel (capacitive touchpanel) 12A and an LCD 12B.

The CPU 101 is a processor which controls actions of various components in the electronic device 1. The CPU 101 loads various types of software from the RAM 107 to the main memory 103 and executes the loaded software. The CPU 101 also executes a basic input/output system (BIOS) stored in the BIOS-ROM 104. The BIOS is a program for hardware control.

The system controller 102 is a device which establishes a connection between a local bus of the CPU 101 and various components. The system controller 102 is equipped with a memory controller which executes access control of the main memory 103. The system controller 102 also has a function of executing communication with the touchpanel controller 105 and the graphics controller 106 via, for example, a serial bus.

The touchpanel controller 105 is a device which inputs a contact position of the active stylus pen 2 or the user's finger on the touchscreen display 12 detected by the touchpanel 12A.

When the active stylus pen 2 is moved to be close to or contacts the touchpanel 12A, a capacitance change occurs at the touchpanel 12A. The touchpanel controller 105 detects the capacitance change of the touchpanel 12A and detects positional coordinates. The positional information thus detected is used for, for example, displaying the hover al as a guide, displaying drawn lines on the LCD 12B, or erasing drawn lines from the LCD 12B. The touchpanel 12A can detect the position of the active stylus pen 2 when the distance between the active stylus pen 2 and the touchpanel 12A is, for example, 10 mm or less. The distance differs according to the detection accuracy of the touchpanel 12A, the dielectric constant of the active stylus pen 2, etc. The active stylus pen 2 transmits a signal on which data such as writing pressure information is superimposed. The touchpanel controller 105 receives input of the signal received by a transparent electrode of the touchpanel 12A, decodes the signal, and acquires the writing pressure information. The transmission signal may be transmitted in a single direction from the active stylus pen 2 to the touchpanel 12A, or may be bi-directionally transmitted between the active stylus pen 2 and the touchpanel 12A.

The graphics controller 106 is a device which controls the LCD 12B. The LCD 12B displays a screen image based on a display signal generated by the graphics controller 106. According to this, the graphics controller 106 can display, on the LCD 12B, a drawn line, etc., corresponding to the contact position of the active stylus pen 2 or the user's finger input by the touchpanel controller 105.

The EC 108 is a one-chip microcomputer including a controller for power management. The EC 108 has a function of powering on or off the electronic device 1 in accordance with a power button operation executed by the user.

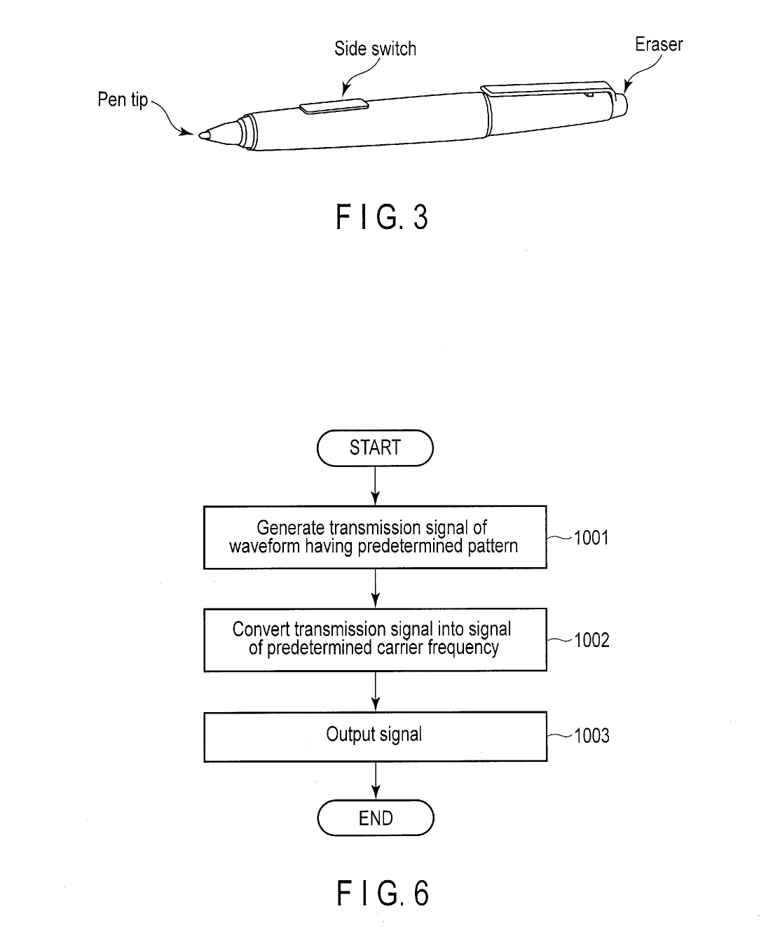

FIG. 3 illustrates an appearance of the active stylus pen 2. As shown in FIG. 3, the active stylus pen 2 includes a pen tip and an eraser each formed of a conductive material. The eraser formed of a conductive material may serve as a cover (cap) which covers the pen tip formed of a conductive material when the active stylus pen 2 is not in use (i.e., when the active stylus pen 2 is being carried). If the eraser serves as the cover, the eraser formed of a conductive material has a function of energizing a circuit in a body of the pen when attached to the end opposite to the pen tip.

The active stylus pen 2 has a mechanism which notifies the touchpanel 12A of a contact position with the touchpanel 12A by, for example, changing capacitance at the contact position. The (mechanism provided in the) active stylus pen 2 is actuated by (power supplied by) a power storage device such as a battery, a capacitor, etc., built in the body of the active stylus pen 2.

The mechanism provided in the active stylus pen 2 is powered by the battery and includes a mechanism, etc., which generates an AC signal in the vicinity of each end (the pen tip and the eraser) of the active stylus pen 2 to compensate for a capacitance change necessary for detecting the contact position by the touchpanel 12A. The active stylus pen 2 can transmit information such as writing pressure, a pen identification number, etc., to the electronic device 1 by using the AC signal as a carrier. The active stylus pen 2 can generate AC signals of different waveforms at the stylus tip end and the eraser end.

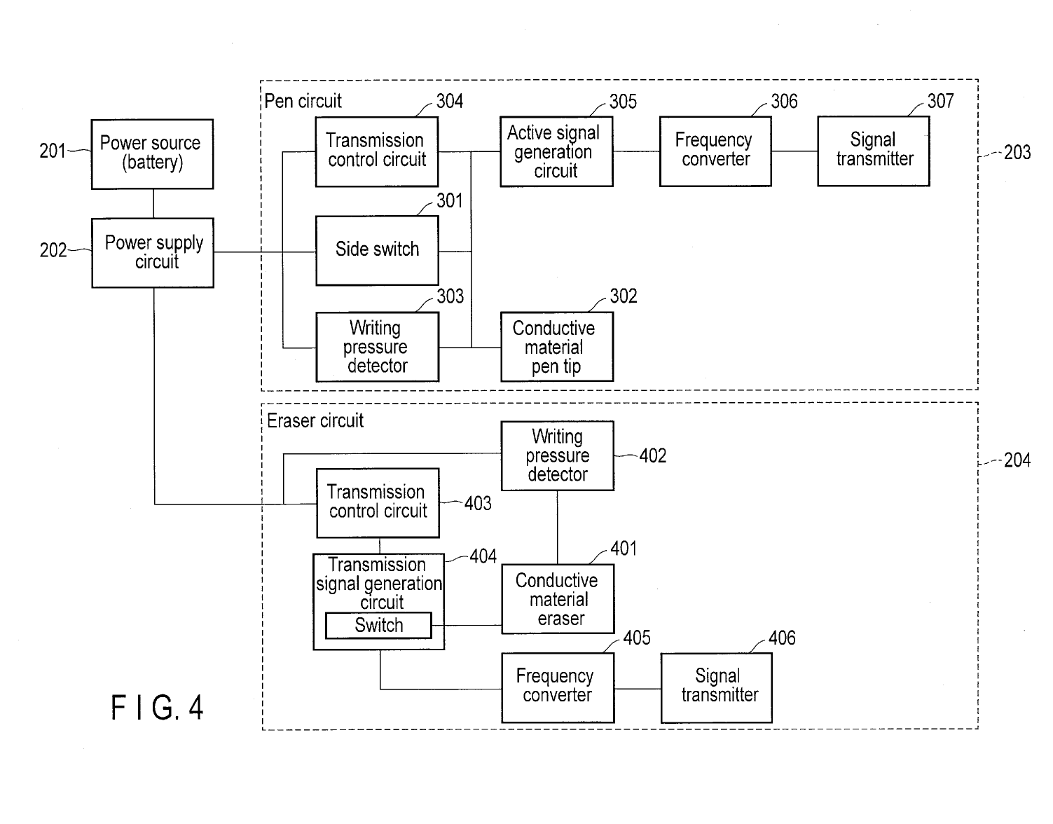

FIG. 4 is a block diagram showing a function configuration of the active stylus pen 2. The active stylus pen 2 shown in FIG. 4 includes a power source (battery) 201, a power supply circuit 202, a pen circuit (a first signal generator) 203 and an eraser circuit (a second signal generator) 204. The pen circuit 203 includes a side switch 301, a conductive material pen tip 302, a writing pressure detector 303, a transmission control circuit 304, an active signal generation circuit (transmission signal generation circuit) 305, a frequency converter 306 and a signal transmitter 307. The eraser circuit 204 includes a conductive material eraser 401, a writing pressure detector 402, a transmission control circuit 403, a transmission signal generation circuit 404, a frequency converter 405 and a signal transmitter 406.

The power supply circuit 202 is a circuit which controls supply of the power supplied from the power source (battery) 201 to various components in the active stylus pen 2. Each component in the active stylus pen 2 is actuated when the power is supplied from the power source (battery) 201 by the power supply circuit 202.

The side switch 301 is an operative unit for powering on and off the active stylus pen 2. The side switch 301 may be an operative unit having a click function. In this case, according to the click function, an operation corresponding to a click of a mouse, etc., can be executed by executing an operation by the pen while the side switch 301 is pressed. The side switch 301 is assumed to be a switch constituted by a button or similar device which can be pressed by a comparatively small power.

The conductive material pen tip 302 is a pen tip of the active stylus pen 2 formed of a conductive material. The conductive material pen tip 302 is mainly used to draw lines.

When an operation (input operation) is executed by the active stylus pen 2 on the touchscreen display 12 and the conductive material pen tip 302 contacts (a screen of) the touchscreen display 12, the writing pressure detector 303 detects a writing pressure in the input operation.

The transmission control circuit 304 is a circuit which controls the active signal generation circuit 305 to generate a transmission signal (active signal) for the electronic device 1.

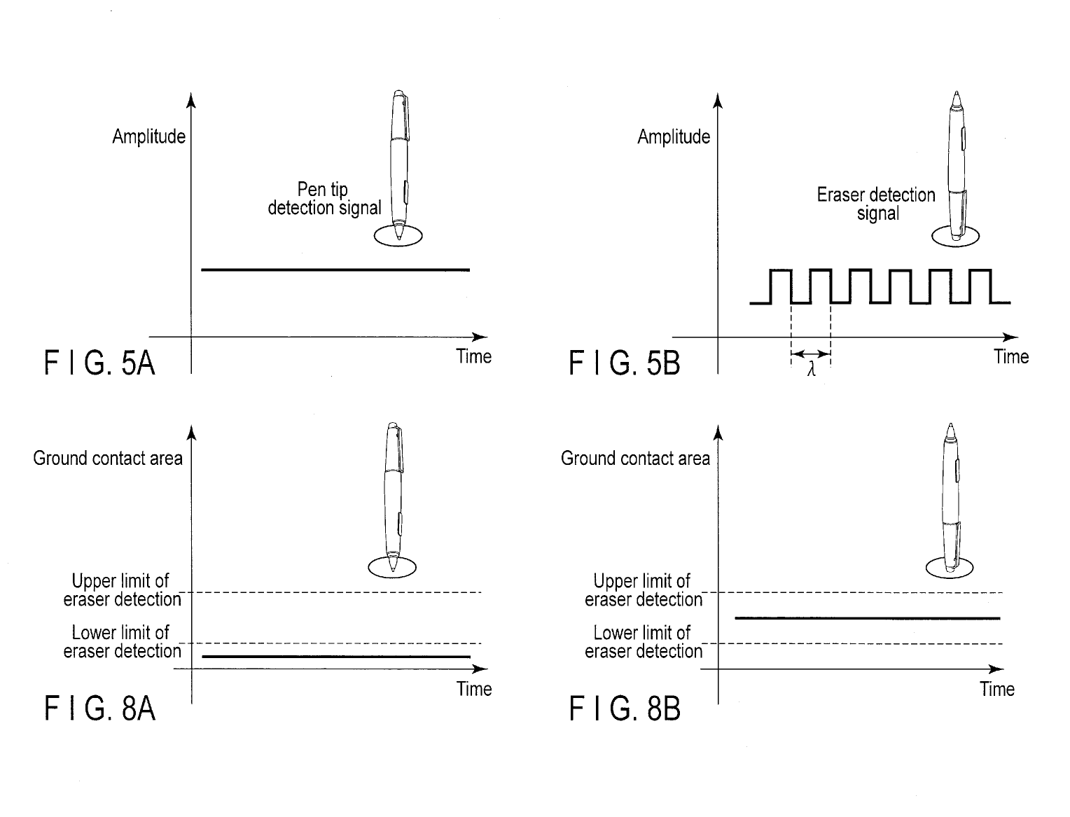

It is assumed that the active stylus pen 2 is powered on and the conductive material pen tip 302 of the active stylus pen 2 is in contact with the touchscreen display 12. In this case, the power is supplied to each component (in the pen circuit 203) by the power supply circuit 202, and the active signal generation circuit 305 generates a transmission signal of, for example, a waveform of FIG. 5A, under the control of the transmission control circuit 304. A position of the conductive material pen tip 302 must be precisely notified to the electronic device 1 (i.e., the electronic device 1 must acquire time-series information corresponding to the movements of the pen tip when a line is drawn). Therefore, the waveform of the transmission signal generated by the active signal generation circuit 305 is always in an on-state (i.e., a state of notifying the position of the pen tip) as shown in FIG. 5A. The transmission signal which is generated in the active signal generation circuit 305 (and functions as a pen tip detection signal) is converted into a signal of a predetermined carrier frequency by the frequency converter 306 and output from the signal transmitter 307 to the electronic device 1. As described above, this transmission signal is a signal for notifying the position of the pen to the electronic device 1. In addition, the transmission signal includes a pen identification number for identifying the active stylus pen 2, information indicating that the conductive material pen tip 302 is directed to the electronic device (i.e., the conductive material eraser is not directed to the electronic device 1), information indicating the writing pressure detected by the writing pressure detector 303, etc. When (the pen tip of) the active stylus pen 2 is thus moved to be close to the touchscreen display 12 while the electronic device 1 is powered on, the hovering function described above can be used, and the hover al shown in FIG. 1 is displayed on the touchscreen display 12 in accordance with the transmission signal.

The description returns to FIG. 4. The conductive material eraser 401 is an eraser of the active stylus pen 2 formed of a conductive material. The conductive material eraser 401 is mainly used to erase a line drawn on the touchscreen display 12.

When an operation (input operation) is executed by the active stylus pen 2 on the touchscreen display 12 and the conductive material eraser 401 contacts (the screen of) the touchscreen display 12, the writing pressure detector 402 detects a writing pressure in this input operation.

The transmission control circuit 403 is a circuit which controls the transmission signal generation circuit 404 including a switch mechanism capable of turning on and off energization of the conductive material eraser 401 to generate a transmission signal for the electronic device 1.

It is assumed that the active stylus pen 2 is powered on and the conductive material eraser 401 of the active stylus pen 2 is in contact with the touchscreen display 12. In this case, the power is supplied to each component (in the eraser circuit 204) by the power supply circuit 202, and the transmission signal generation circuit 404 generates a transmission signal of, for example, a waveform shown in FIG. 5B, under the control of the transmission control circuit 403. A position of the conductive material eraser 401 does not need to be precisely notified to the electronic device 1 (i.e., the electronic device 1 needs only specify time-series information within a range corresponding to movements of the eraser). Therefore, the waveform of the transmission signal generated by the transmission signal generation circuit 404 alternately repeats an on-state and an off-state (i.e., a state of notifying the position of the eraser and a state of not notifying the position, or a state where the switch mechanism in the transmission signal generation circuit 404 is turned on and the power is supplied to the conductive material eraser 401 and a state where the switch mechanism is turned off and the power is not supplied) as shown in FIG. 5B. The waveform of the transmission signal generated by the transmission signal generation circuit 404 is not limited to the pattern shown in FIG. 5B, but may be any pattern if it is a predetermined pattern consisting of a combination of the on-state and the off-state. This predetermined pattern is recognized by firmware of the touchpanel controller 105. When the predetermined pattern prepared for the eraser is detected, the eraser is determined to be in contact with the touchpanel 12A. The touchpanel controller 105 detects the predetermined pattern by detecting an envelope of the input signal. When the contact between the eraser and the touchpanel 12A is detected, the touchpanel controller 105 compensates for positional coordinates of thinned portions (portions of the off-state of the predetermined pattern) in the detected positional coordinates based on the detected positional coordinates (i.e., makes the positional coordinates into continuous information), and transfers the compensated coordinates to a drawing display module. It should be noted that the waveform of the transmission signal generated by the transmission signal generation circuit 404 should be a pattern which falls within a scan rate of the electronic device 1. The transmission signal which is generated in the transmission signal generation circuit 404 (and functions as an eraser detection signal) is converted into a signal of a predetermined carrier frequency by the frequency converter 405 and output from the signal transmitter 406 to the electronic device 1. As described above, this transmission signal is also a signal for notifying the electronic device 1 of the position of the pen. The transmission signal includes the above-described pen identification number, information indicating the writing pressure detected by the writing pressure detector 402, etc. When the eraser is moved to be close to the touchscreen display 12, the above-described the hover al in accordance with hovering function does not need to be displayed. In this case, the eraser circuit 204 starts signal generation by regarding detection of the writing pressure of the eraser as a trigger. During the signal generation for the eraser, the signal generation for the pen (pen tip) is not executed. The area of a drawing erasure region and the density of erasure may be changed in accordance with the writing pressure detected by the writing pressure detector 402 of the eraser circuit 204. To change the area of the drawing erasure region, compatibility with the application is necessary.

In the present embodiment, each of the pen circuit 203 and the eraser circuit 204 includes a frequency converter and a signal transmitter. However, the frequency converter and the signal transmitter may be commonly used by both the pen circuit 203 and the eraser circuit 204. Furthermore, in the present embodiment, the power supply circuit 202 acquires the power from the battery 201 and the acquired power is supplied to the pen circuit 203 and the eraser circuit 204. However, since the power which is consumed in the eraser circuit 204 is small, an electromotive force generation mechanism which generates an electromotive force by utilizing a phenomenon such as friction, pressure, etc., caused by the action of using the active stylus pen 2 may be independently included in the eraser circuit 204.

Next, the active stylus pen 2 is assumed to be powered off. In this case, the supply of power of the power supply circuit 202 to each component (in the pen circuit 203 and the eraser circuit 204) is suppressed (turned off), and the output of the transmission signal from the active stylus pen 2 is stopped. In such a case where the power is turned off, the above-described hovering function cannot be used and the hover al shown in FIG. 1 is not displayed on the touchscreen display 12 even if the active stylus pen 2 is moved to be close to the touchscreen display 12. Furthermore, even if the pen tip of the active stylus pen 2 is brought into contact with the touchscreen display 12, a drawn line is not displayed on the touchscreen display 12 (i.e., a line is not drawn). Moreover, even if the eraser of the active stylus pen 2 is brought into contact with the touchscreen display 12, a drawn line on the touchscreen display 12 is not erased.

Actions of the active stylus pen 2 executed when the active stylus pen 2 is powered on and the conductive material eraser 401 is brought into contact with the touchscreen display 12 of the electronic device 1 are hereinafter described with reference to a flowchart of FIG. 6. It is assumed that one or more lines are displayed (drawn) on the touchscreen display 12 of the electronic device 1.

In this case, the transmission signal generation circuit 404 first generates a transmission signal of a waveform having a predetermined pattern while repeating turning on and off the switch mechanism under the control of the transmission control circuit 403 (block 1001). By this transmission signal, the contact of the conductive material eraser 401 of the active stylus pen 2 with the touchscreen display 12 (i.e., an instruction to enable an eraser function) and the position of the active stylus pen 2 (i.e., a position of a line to be erased of the above-described one or more lines) can be detected in the electronic device 1.

Next, the frequency converter 405 converts the transmission signal generated by the transmission signal generation circuit 404 to a signal of a predetermined carrier frequency (block 1002).

Then, the signal transmitter 406 outputs the signal converted by the frequency converter 405 to the electronic device 1 (block 1003), and ends the processing.

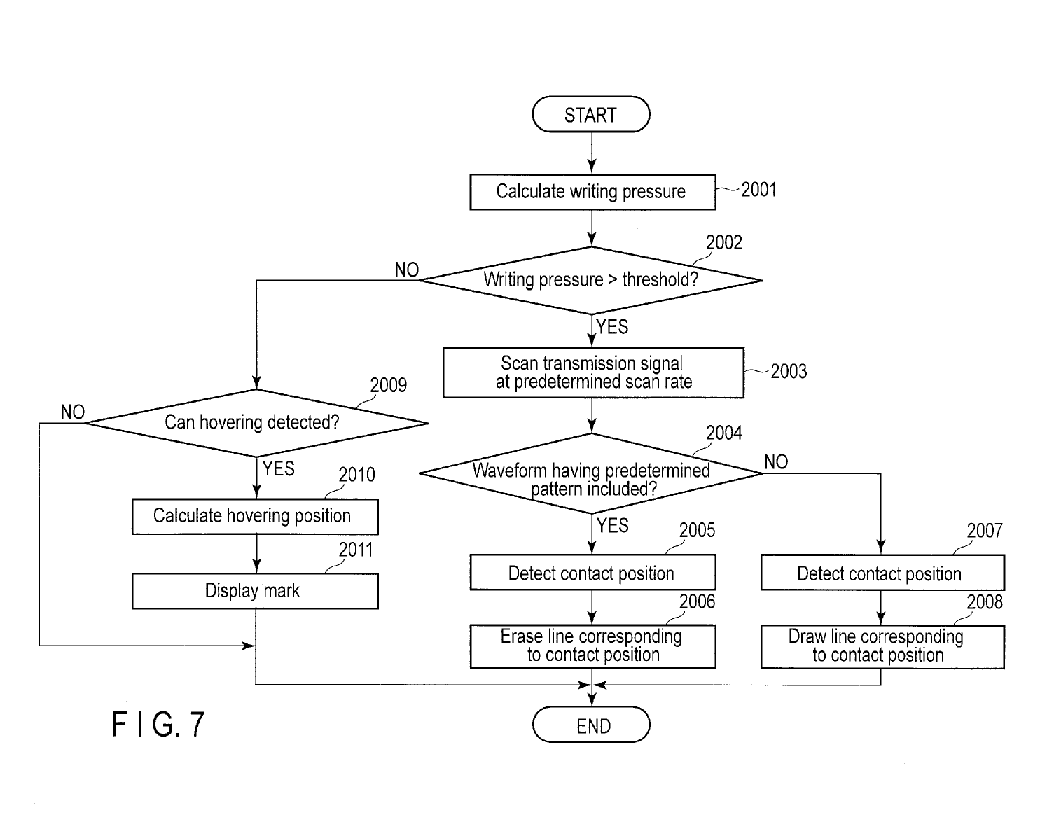

Next, actions of the electronic device 1 executed when the operation is executed for the electronic device 1 by the active stylus pen 2 are hereinafter described with reference to a flowchart of FIG. 7.

If the user moves (the pen tip of) the active stylus pen 2 powered on for the operation of the electronic device 1 to be close to the touchscreen display 12, the touchpanel 12A included in the electronic device 1 can receive the transmission signal output from the active stylus pen 2. That is, if (the pen tip of) the active stylus pen 2 is positioned within a certain distance from the touchscreen display 12, the active stylus pen 2 can be detected in the electronic device 1.

If the active stylus pen 2 positioned within the certain distance is detected in the electronic device 1 and the transmission signal is received by the touchpanel 12A, a writing pressure of the active stylus pen 2 on the touchscreen display 12 is calculated in the electronic device 1 based on information indicating the writing pressure included in the transmission signal (block 2001).

Next, it is determined in the electronic device 1 whether the calculated writing pressure exceeds a predetermined value (threshold) (block 2002). In the process of block 2002, it is determined whether the active stylus pen 2 is in contact with the touchscreen display 12 included in the electronic device 1.

If it is determined that the writing pressure exceeds the predetermined value (YES in block 2002), the touchpanel 12A scans the transmission signal output from the active stylus pen 2 at a predetermined scan rate (block 2003).

Next, in the electronic device 1, it is determined whether a waveform having a predetermined pattern, i.e., a waveform of the transmission signal output from the eraser circuit 204 of the active stylus pen 2 is included in a waveform of the transmission signal scanned at the predetermined scan rate (block 2004).

If it is determined that the waveform having the predetermined pattern is included (YES in block 2004), the touchpanel controller 105 detects a reception position of the transmission signal output from the eraser circuit 204 on the touchscreen display 12 (i.e., a contact position of the active stylus pen 2) (block 2005).

In this case, the graphics controller 106 executes processing for erasing a line drawn at a contact position (drawing erasure region) detected by the touchpanel controller 105 (block 2006).

If it is determined that the waveform having the predetermined pattern is not included (NO in block 2004), the touchpanel 12A detects a reception position of the transmission signal output from the pen circuit 203 on the touchscreen display 12 (i.e., a contact position of the active stylus pen 2) (block 2007).

In this case, the graphics controller 106 executes drawing processing in accordance with the contact position detected by the touchpanel controller 105 (block 2008), and displays on the LCD 12B a dawn line according to the contact position.

If it is determined that the writing pressure does not exceed the predetermined value (NO in block 2002), the touchpanel 12A determines whether hovering can be detected based on the received transmission signal (block 2009). In this case, if the active stylus pen 2 is positioned within a certain distance from the touchscreen display 12, the touchpanel 12 determines that the position of the active stylus pen 2 can be specified and the hovering can be detected. It is assumed that the certain distance by which the position of the active stylus pen 2 can be specified is less than the above-described certain distance by which the active stylus pen 2 can be detected.

If it is determined that hovering can be detected (YES in block 2009), a hovering position is calculated based on the reception position of the transmission signal of the touchpanel 12A (block 2010).

In this case, the graphics controller 106 displays a mark (for example, mark al shown in FIG. 1) at the hovering position thus calculated (block 2011). The user can thereby use the hovering function while the active stylus pen 2 is not in contact with the touchscreen display 12.

If it is determined that hovering cannot be detected (NO in block 2009), the processes of blocks 2010 and 2011 is not executed and the processing is ended.

The present embodiment makes it possible to determine which of the pen tip and the eraser is in contact with the touchscreen display 12 of the electronic device 1 (i.e., enables eraser recognition) by intentionally making the waveform of the transmission signal output from the pen circuit 203 different from the waveform of the transmission signal output from the eraser circuit 204 in the pattern. However, ground contact area information described later may be further used to lower a false detection ratio of the eraser recognition. The ground contact area information is information indicating the area (ground contact area) of a portion (i.e., the pen tip or the eraser) in contact with the touchscreen display 12 of the electronic device 1. That is, when the ground contact area indicated by the ground contact area information is smaller than a lower limit of eraser detection as shown in FIG. 8A, the electronic device 1 determines that the pen tip is in contact with the touchscreen display 12. When the ground contact area indicated by the ground contact area information is larger than the lower limit of eraser detection and smaller than an upper limit of eraser detection as shown in FIG. 8B, the electronic device 1 determines that the eraser is in contact with the touchscreen display 12. By using the ground contact area information in addition to the patterns of the waveform of the transmission signal as described above, the electronic device 1 determines that the eraser is in contact with the touchscreen display 12 (i.e., enables the eraser function) only when the ground contact area indicated by the ground contact area information is larger than the lower limit of eraser detection and smaller than the upper limit of eraser detection, and the waveform having the predetermined pattern is included in the waveform of the transmission signal, and determines that the pen tip or the finger is in contact with the touchscreen display 12 (i.e., disabling the eraser function) in other cases. The false detection ratio of the eraser recognition can be thereby lowered.

In the present embodiment, the conductive material eraser 401 is used to enable the eraser function. However, the conductive material eraser 401 may be used to enable a function other than the eraser function (for example, a scaling function or a highlighting function).

According to the embodiment described above, the active stylus pen 2 includes the eraser circuit 204 which outputs the transmission signal different from the transmission signal output from the pen circuit 203 in waveform, and is configured to determine which of the conductive material pen tip 302 and the conductive material eraser 401 is in contact with the touchscreen display 12 of the electronic device 1. Therefore, the users can intuitive use the eraser function by an operation such as inverting the active stylus pen 2.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An active stylus pen which is actuated by power supplied from a built-in power storage device and comprises a conductive pen tip and a conductive eraser capable of being arranged at a position facing the pen tip, the active stylus pen comprising:
a first signal generator which generates a first signal capable of notifying an electronic device capable of accepting an operation executed by the active stylus pen that the pen tip is in contact with the electronic device when an operation of bringing the pen tip into contact with the electronic device is executed;
a second signal generator which generates a second signal capable of notifying the electronic device that the eraser is in contact with the electronic device when an operation of bringing the eraser into contact with the electronic device is executed; and
a transmitter which outputs any one of the first signal and the second signal to the electronic device in order to enable a predetermined function of the electronic device corresponding to the first signal or the second signal,
the first signal and the second signal being AC signals configured to increase a capacitance change in a touchpanel comprised in the electronic device when the active stylus pen is moved to be close to the touchpanel.

2. The active stylus pen of claim 1, wherein
the second signal generator generates the second signal of a waveform having a predetermined pattern different from the first signal.

3. The active stylus pen of claim 1, wherein
the second signal generator generates the second signal of a waveform having a pattern which falls within a predetermined scan rate of the electronic device.

4. The active stylus pen of claim 1, wherein
the first signal generator continuously supplies the power supplied from the power storage device to the pen tip and generates the first signal, and
the second signal generator intermittently supplies the power supplied from the power storage device to the eraser and generates the second signal.

5. An electronic device capable of accepting an operation executed by an active stylus pen comprising a conductive pen tip and a conductive eraser capable of being arranged at a position facing the pen tip, the electronic device comprising:
a receiver which receives a signal output from the active stylus pen by an operation executed by the active stylus pen;
a signal determination processor which executes determination processing for determining whether the received signal is a signal indicating that an operation is executed by the pen tip or a signal indicating that an operation is executed by the eraser; and
a function switching processor which enables a first function when the received signal is the signal indicating that the operation is executed by the pen tip, and enables a second function when the received signal is the signal indicating that the operation is executed by the eraser, based on a result of the determination.

6. The electronic device of claim 5, wherein
the first function is a function of enabling a line to be drawn on a screen of the electronic device, and
the second function is a function of enabling the line drawn on the screen of the electronic device to be erased.

7. The electronic device of claim 5, wherein
the receiver comprises:
a first processor which receives writing pressure information indicating a writing pressure of the active stylus pen against the electronic device; and
a second processor which determines whether the active stylus pen is in contact with a screen of the electronic device based on the received writing pressure information, and
the signal determination processor executes the determination processing when it is determined that the active stylus pen is in contact with the screen of the electronic device.

8. The electronic device of claim 5, wherein
the receiver scans the signal output from the active stylus pen at a predetermined scan rate and receives the output signal.

9. A data input system comprising an active stylus pen which is actuated by power supplied from a built-in power storage device and comprises a conductive pen tip and a conductive eraser capable of being arranged at a position facing the pen tip, and an electronic device capable of accepting an operation executed by the active stylus pen,
the active stylus pen comprising:
a first signal generator which generates a first signal capable of notifying an electronic device capable of accepting an operation executed by the active stylus pen that the pen tip is in contact with the electronic device when an operation of bringing the pen tip into contact with the electronic device is executed;
a second signal generator which generates a second signal capable of notifying the electronic device that the eraser is in contact with the electronic device when an operation of bringing the eraser into contact with the electronic device is executed; and
a transmitter which outputs any one of the first signal and the second signal to the electronic device in order to enable a predetermined function of the electronic device corresponding to the first signal or the second signal,
the electronic device comprising:
a receiver which receives a signal output from the active stylus pen by an operation executed by the active stylus pen;
a signal determination processor which determines whether the received signal is a first signal or a second signal; and
a function switching processor which enables a first function when the received signal is the first signal, and enables a second function when the received signal is the second signal, based on a result of the determination,
the first signal and the second signal being AC signals configured to increase a capacitance change in a touchpanel comprised in the electronic device when the active stylus pen is moved to be close to the touchpanel.
